(19) United States
(12) Patent Application Publication
(10) Pub. No.: US 2008/0306841 A1
(43) Pub. Date: Dec. 11, 2008

(54) System and method for processing orders

(75) Inventor: Richard K. C. Chang, II, Metamora, IL (US)

Correspondence Address: CATERPILLAR c/o LIELL, MCNEIL & HARPER, P.O. BOX 2417, 511 SOUTH MADISON STREET, BLOOMINGTON, IN, 47402-2417, US

(73) Assignee: Caterpillar Inc.

(21) Appl. No.: 11/810,899

(22) Filed: Jun. 7, 2007

(51) Int. Cl. G06Q 10/00

(52) U.S. Cl. 705/28

(57) ABSTRACT

An order processing system includes a staging area for receiving a shipping medium prior to shipment. The shipping medium supports at least one item. An imaging device is positioned for capturing an image of the at least one item supported by the shipping medium. A data storage device is configured to store the image and order information associated with the image.

### TECHNICAL FIELD

The present disclosure relates generally to a system and method for processing orders, and more particularly to a system and method for capturing an image of at least one item supported by a shipping medium prior to shipment.

### BACKGROUND

Manufacturing and distribution facilities receive and process numerous orders. These orders may include a variety of items and/or large quantities of a specific item, and are filled by employees of the facilities using various shipping media ranging from small boxes to large, multi-layer pallets.

Due to the tedious nature of filling numerous orders, errors may occur during the packaging process. In the event that a customer receives an incorrect or missing item in their order, the customer typically files a claim with the manufacturing or distribution facility. Investigating and remedying these packaging error claims can contribute to significant losses in time and money, especially when the manufacturing and/or distribution facility does not have any process in place for verifying the contents of the shipping media prior to shipment.

Oftentimes, manual verification processes are implemented to ensure the accuracy of an order prior to shipment. These processes include the manual review of the contents of a shipping medium after packaging using the order itself or other checklist, and the use of automated devices that scan bar codes or other identifying information for each item as it is packaged. For example, U.S. Pat. No. 5,083,283 discloses a shipping method that utilizes bar codes to identify packaged items. Specifically, as individual bar coded items are packed within a container, a packer uses a bar code reader connected to a shipping location computer to initially read the bar code label of each item packed within the container. Software in the computer then creates a unique container label that is associated with each scanned item. This method, however, is still subject to human error, in the event that a packed item is scanned multiple times or is not scanned at all, and does not offer a quick and reliable way of verifying the contents of a particular shipping medium, prior to shipment, in response to a customer inquiry.

The present disclosure is directed to one or more of the problems set forth above.

### SUMMARY OF THE DISCLOSURE

In one aspect, an order processing system includes a staging area for receiving a shipping medium prior to shipment. The shipping medium supports at least one item. An imaging device is positioned for capturing an image of the at least one item supported by the shipping medium. A data storage device is configured to store the image and order information associated with the image.

In another aspect, a method of processing an order includes a step of receiving an order, wherein the order identifies a plurality of items. The method also includes a step of storing an order record associated with the order in a data storage device. The method also includes steps of supporting a first layer of the plurality of items with a shipping medium, and capturing a first image of the first layer of the plurality of items supported by the shipping medium with an imaging device. Also included in the method are the steps of associating the first image with the order record, and shipping the shipping medium.

In a further aspect, a method of processing an order, storing information associated with the order, and accessing the information includes steps of receiving an order, wherein the order identifies a plurality of items, and storing an order record associated with the order in a data storage device. The method also includes steps of supporting a first layer of the plurality of items with a shipping medium, and capturing a first image of the first layer of the plurality of items supported by the shipping medium with an imaging device. The method also includes steps of supporting a second layer of the plurality of items with the shipping medium, and capturing a second image of the second layer of the plurality of items supported by the shipping medium with the imaging device. The method further includes steps of securing the first and second layers of the plurality of items to the shipping medium, and capturing a final image of the shipping medium once secured. The method further includes steps of associating the first, second, and final images with the order record, shipping the shipping medium, and accessing the order record and the first, second, and final images.

### BRIEF DESCRIPTION OF THE DRAWINGS

FIG. 1 is a schematic view of an order processing system according to the present disclosure;

FIG. 1A is a schematic view of an alternative shipping medium of the order processing system of claim 1;

FIG. 2 is an exemplary image of a first layer of a shipping medium according to the present disclosure;

FIG. 3 is an exemplary image of a second layer of a shipping medium according to the present disclosure;

FIG. 3A is an alternative image of the second layer of a shipping medium according to the present disclosure;

FIG. 4 is an exemplary image of a third layer of a shipping medium according to the present disclosure;

FIG. 5 is a flow chart of one embodiment of a method for processing an order according to the present disclosure; and

FIG. 6 is a flow chart of one embodiment of a method for accessing an order record and image according to the present disclosure.

### DETAILED DESCRIPTION

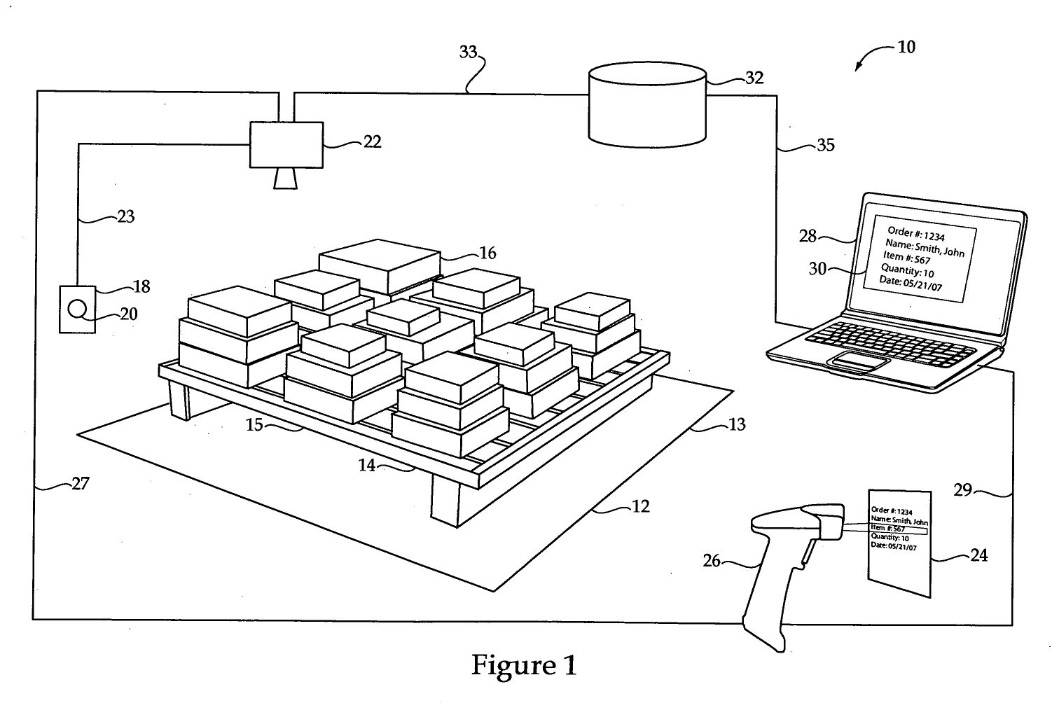

An exemplary embodiment of an order processing system 10 is shown generally in FIG. 1. A manufacturing and/or distribution facility may include a staging area 12 for packaging one or more items of an order. The staging area 12 is a location or area through which a shipping medium passes prior to shipment, and may include, for example, a floor 13 (as shown), counter, table, or any other area where one or more items of an order may be packaged. The one or more items of the order may have been placed into or supported by the shipping medium prior to its reaching the staging area 12 or, alternatively, the items comprising the order may be placed in the shipping medium at the staging area 12. The staging area 12 is sized to accommodate shipping media of various sizes, and may incorporate the use of employees and/or various automated or electronic devices for placing the items of the order into the shipping medium.

The order may reflect a customer order and may include any number and type of items. For example, in the machinery industry, the one or more items may include parts or subassemblies for machinery. Each item or group of items may be provided in individual containers, such as, for example, boxes. The order may be shipped via any known shipping media 14, such as, for example, a case, a box, or a pallet 15 (as shown). Shipping medium 14 is shown having several items supported thereon, including an individually packaged item 16. The order may include item 16 only, or item 16 and one or more additional items. Alternatively, as shown in FIG. 1A, a box 17 may be the desired medium for packaging item 16 and one or more additional items. After the order is filled, i.e., each item of the order is placed on or within the shipping medium 14, the shipping medium 14 may be sealed and/or the one or more items of the order may be secured to the shipping medium 14 at the staging area 12. For example, if the shipping medium 14 comprises a pallet 15, as shown, it may be desirable to shrink-wrap one or more layers of the shipping medium 14 or the entire shipping medium 14.

The system 10 also includes a triggering device 18 operably connected to an imaging device. Specifically, the triggering device 18 may be a manual triggering device, as shown, located remotely from the imaging device and may include a push button 20 for causing the imaging device, such as, for example, camera 22, to capture an image of the contents of shipping medium 14. It should be appreciated that “contents,” as used herein, refers to items placed within shipping medium 14 or items supported with or by the shipping medium 14. The triggering device 18 communicates with the camera 22 via a communications line 23. Communications line 23 may be any type of communications line, as will be appreciated by those skilled in the art, and may include a wired or wireless connection.

Although a manual triggering device 18 is shown, it should be appreciated that an automatic or timed triggering device may be used to cause the camera 22 to capture an image of the contents of shipping medium 14. For example, the staging area 12 may be configured to sense a placement of shipping medium 14 and electronically actuate the triggering device 18 in response to the placement. Alternatively, a timer may cause the camera 22 to capture an image of the contents of the shipping medium 14 a predetermined time period after a triggering event has occurred. Such a triggering event may, for example, include scanning a slip 24 representative of an order with a scanning device 26. The scanning device 26 may communicate with the camera 22 via a communications line 27. In addition, the scanning device 26 may communicate with a workstation 28 via a communications line 29. After scanning the slip 24, the scanning device 26 may create or link to an order record that may be accessed or stored by the workstation 28. For example, an electronic representation 30 of the order is shown on workstation 28.

The camera 22 may be a digital camera for capturing digital images, or any other camera or device, capable of capturing one or more images and storing the one or more images internally or in an alternate data storage device, such as, for example, a database 32. While any desired resolution of images may be used, low resolution images, which require less storage space in memory, may be captured and stored. Alternatively, a higher resolution image may be desired to view bar code or various other information on a surface of the shipping medium 14 and/or an item supported by the shipping medium 14, such as, for example, item 16. It may be desirable to capture a plurality of images corresponding to distinct portions of the shipping medium 14 and/or distinct layers of the shipping medium 14.

The database 32 may receive the one or more images captured by camera 22 via a communications line 33. Alternatively, or in conjunction with an image, the database 32 may store information associating the image with the shipping medium 14. As should be appreciated, any known way of linking the image to the shipping medium 14 is contemplated. It may further be desirable to link or associate this information with specific order information. Typically, manufacturing and distribution facilities store a plurality of records associated with each customer order in a database, such as database 32. Each record may include an order identifier, one or more item identifiers, a receiving party identifier, an employee identifier, a date shipped, and any other relevant information. It may be desirable to include with this record an identification of the shipping medium 14 used to transport the one or more items of the order. Additionally, it may be desirable to include a link to or association with the one or more images of the contents of the shipping medium 14, and other shipping media used, prior to shipment.

The order record and/or image(s) may be accessed via a workstation, or other similar device, such as the workstation 28 via a communications line 35. Employees of the manufacturing and/or distribution facilities may, for example, access the order record in response to a customer inquiry or to perform a random or routine audit of employee work quality. It may be desirable to view the one or more images to determine if the one or more items supported by the shipping medium 14 or included within the shipping medium 14 correspond to the customer order.

It may be desirable to store the image and/or order information for a predetermined claims period, such as, for example, six months or any other desired time period. For example, if a manufacturing and/or distribution facility honors or responds to claims for only a predetermined period of time, it may be desirable to delete or write over the image and/or order information after such a claims period has expired. This storage space can then be reused by the system 10.

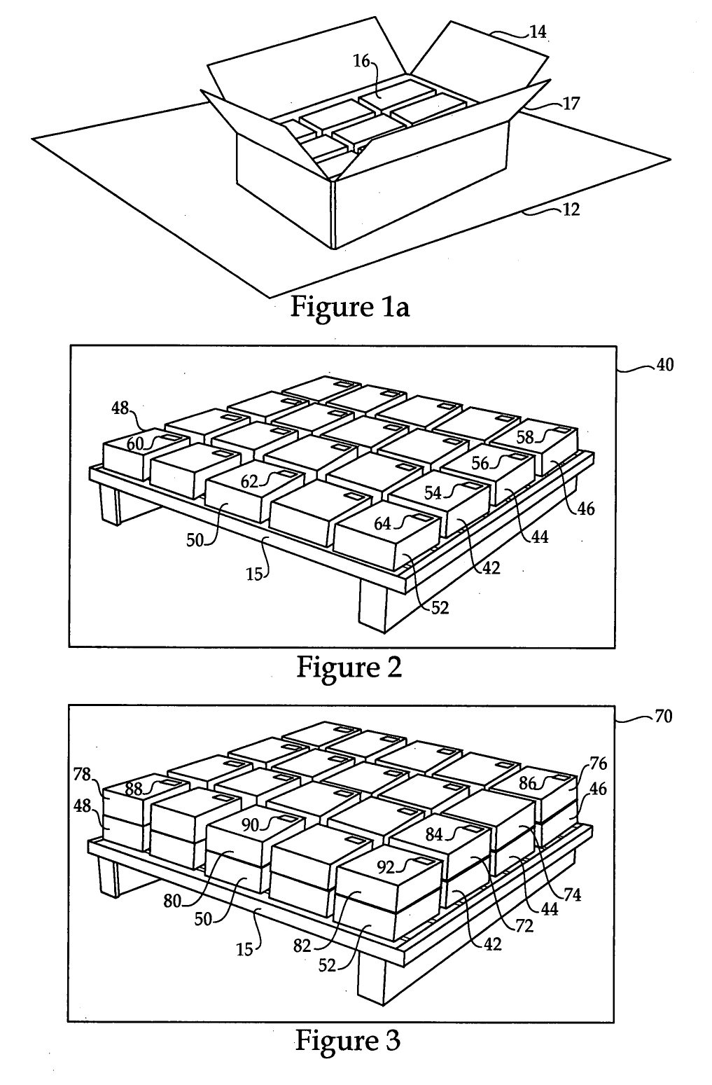

Each shipping medium 14 may include one or more layers and, therefore, it may be desirable to capture an image of each layer of the shipping medium 14 in order to accurately record the contents of, or items supported by, the shipping medium 14. For example, an image 40 of a first layer of shipping medium 14 or, more specifically, a pallet 15 is shown in FIG. 2. The first layer, according to the example, includes several items, such as items 42, 44, 46, 48, 50, and 52. Although a specific number of items are shown, it should be appreciated that any number of items comprising an order may be supported by pallet 15. Each of the items 42, 44, 46, 48, 50, and 52, as shown, are packaged in individual containers and may represent a part for machinery to be shipped to a customer in fulfillment of a customer order. As can be seen in the image 40, each of the items 42, 44, 46, 48, 50, and 52 may include a bar code or other identifying information 54, 56, 58, 60, 62, and 64, respectively, placed thereon. This information may represent identifying information regarding the packaged part.

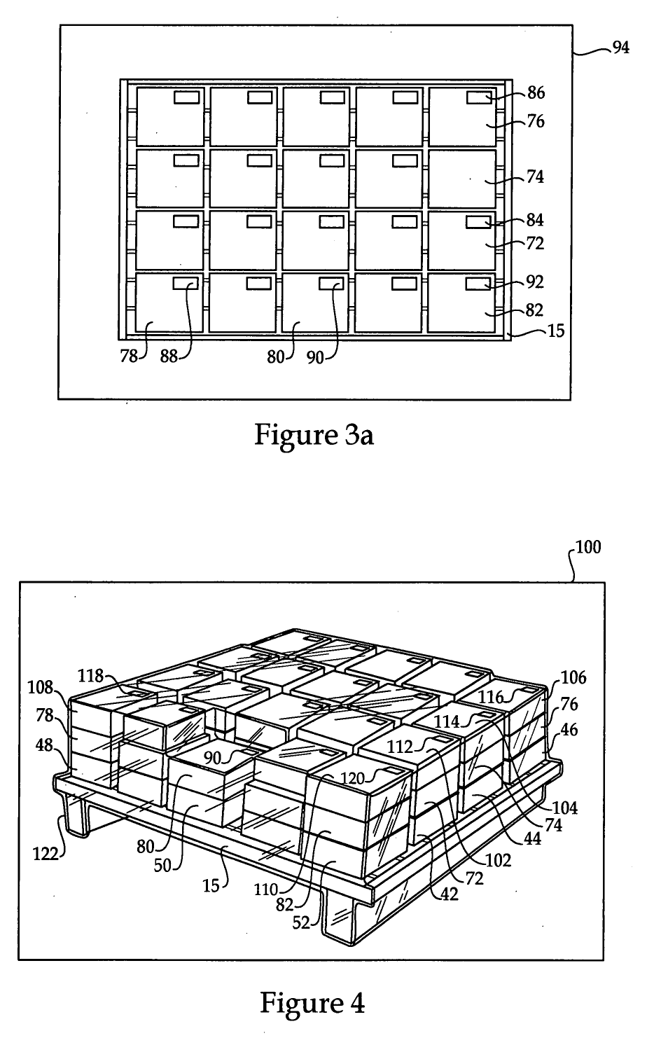

An image 70 representing a second layer of pallet 15 is shown in FIG. 3. As shown, the second layer includes several parts, such as parts 72, 74, 76, 78, 80, and 82. Part 72 includes a bar code 84 and parts 76, 78, 80, and 82 include bar codes 86, 88, 90, and 92, respectively. Alternatively, an image 94 of the second layer, or any other layer, may be captured from above, as shown in FIG. 3A. Turning now to FIG. 4, an image 100 of a third layer of pallet 15 is shown. The third layer includes several parts, such as parts 102, 104, 106, 108, and 110, and each of the parts includes a bar code 112, 114, 116, 118, and 120, respectively. The third layer may include a protective layer 122 placed around the pallet 15 and items supported by the pallet 15 after the order has been filled.

The images of FIGS. 2, 3, and 4 each reflect a layer of pallet 15. If the items supported with pallet 15 represent a customer order, it can be determined by viewing the images 40, 70, and 100 exactly how many parts were shipped to a customer via pallet 15. The condition and positioning of the parts can also be determined by viewing the images 40, 70, and 100. These images may be electronically associated with the pallet 15, and may further be associated with the customer order record, and stored in the database 32 for later reference.

### INDUSTRIAL APPLICABILITY

Referring to FIGS. 1-4, an order processing system 10 includes a staging area 12 for packaging items of an order into or supporting items of an order with a shipping medium 14 prior to shipment. The shipping medium 14 may include one or more layers, wherein each of the layers contains one or more items. Due to the tedious nature of filling numerous orders, errors may occur during the packaging process. In the event that a customer receives an incorrect or missing item, the customer typically files a claim with the manufacturing or distribution facility. Investigating and remedying these packaging error claims can contribute to significant losses in time and money, especially when the manufacturing or distribution facility does not have any process in place for verifying the contents of the shipping medium 14 prior to shipment.

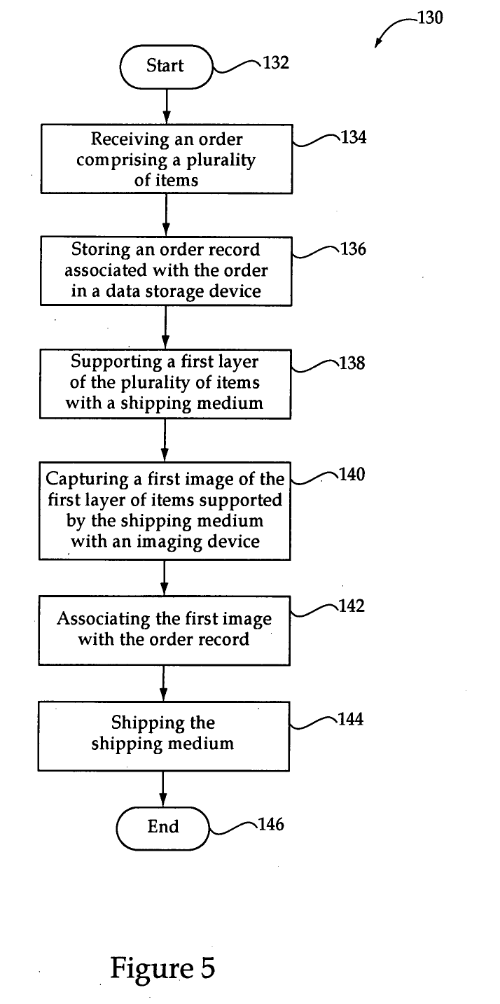

Utilizing the system and method of processing orders according to the present disclosure may help to expedite the resolution of these claims. Turning to FIG. 5, there is shown a flow chart 130 representing an exemplary method of processing an order utilizing the system 10 of FIG. 1. The method begins at a START, Box 132. From Box 132, the method proceeds to Box 134, which includes the step of receiving an order, such as order 24, comprising a plurality of items. An order record associated with the order is stored in the database 32, at Box 136. From Box 136, the method proceeds to Box 138 where a first layer of the plurality of items of the order is supported with the shipping medium 14. At Box 140, the camera 22, which may be placed above, or otherwise in close proximity to, the staging area 12, captures an image of the first layer of items supported by shipping medium 14. An exemplary image of the first layer is shown in FIG. 2.

If multiple layers of the shipping medium 14 are required to support the plurality of items, it may be desirable to capture an image of each layer. For example, a second image of the second layer of shipping medium 14 may be captured, as shown in FIG. 3. An alternative image of the second layer of shipping medium 14 is shown in FIG. 3A. An image of a third layer is shown in FIG. 4. It may also be desirable to capture a final image of the shipping medium 14 after the shipping medium 14 has been sealed or the plurality of items supported by the shipping medium 14 have been secured, such as by protective layer 122.

At Box 142, one or more images, such as, for example, the first image 40, the second image 70, and the third image 100 may be associated with the order record. The images 40, 70, and 100 may be stored in a memory of the camera 22 or, alternatively, may be stored in the database 32. The images 40, 70, and 100 may further be associated with or linked to the specific customer order they represent. After the one or more images 40, 70, and 100 have been captured and stored, the method proceeds to Box 144 where the shipping medium 14 is sealed and/or secured and shipped. The method then proceeds to an END, at Box 146.

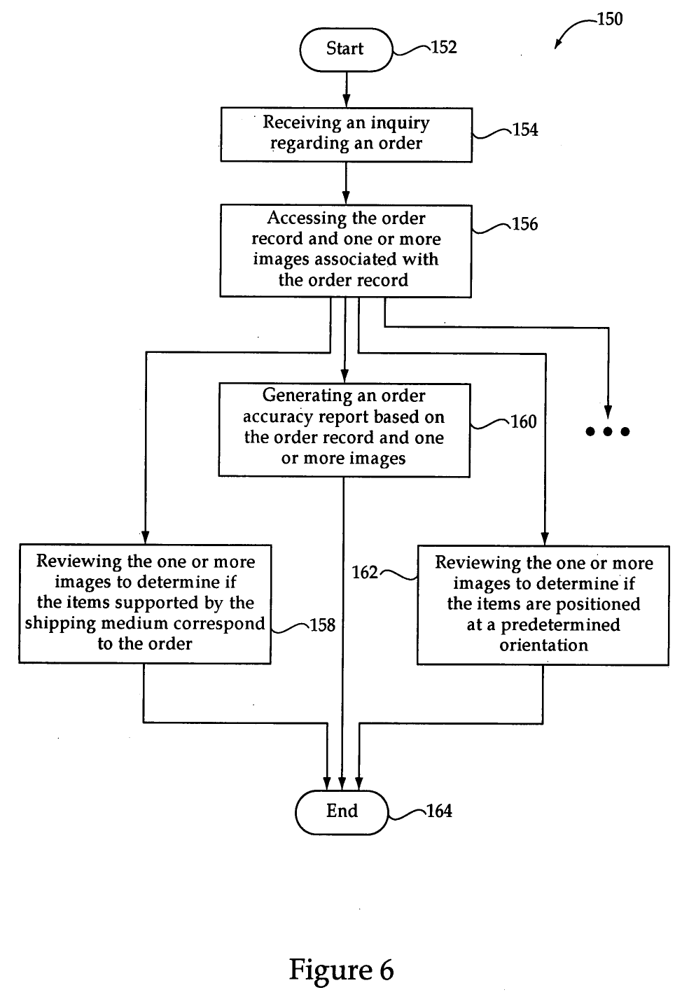

Turning now to FIG. 6, there is shown a flow chart 150 representing an exemplary method of accessing the order record and one or more images stored by the method of FIG. 5. The method begins at a START, Box 152. From Box 152, the method proceeds to Box 154, which includes the step of receiving an inquiry regarding an order, such as order 24. At Box 156, the order record and one or more images associated with the order are accessed. For example, an inquiry regarding the order may be received. This inquiry may reflect a customer's claim that one or more items of the order are missing or incorrect. For example, the customer may claim that a specific number of parts were ordered and that a different number of parts were received via shipping medium 14. Employees of the manufacturing and/or distribution center may access the images 40, 70, and 100 associated with the shipping medium 14 via workstation 30 in response to the inquiry, at Box 158. Employees may utilize each of the images 40, 70, and 100 to determine if the images accurately reflect or correspond to the customer order. If employees confirm that a specific number of items were ordered and a different number of items were sent, they can quickly and accurately determine, by viewing the images 40, 70, and 100, whether or not the contents of shipping medium 14 accurately reflected the customer order prior to shipment. For instances where the one or more images indicate the order was accurately filled and shipped, it may be desirable to provide the customer with the one or more images as proof of the accurate shipment.

It may also be desirable to randomly or routinely access the images to evaluate employee work quality, at Box 160. For example, if images 40, 70, and 100 were accessed, a supervisor or manager may be able to easily determine whether or not the employee responsible for packaging the shipping medium 14 satisfactorily filled the customer order. This information, along with other information specifying the work quality of a specific employee, may be included in an employee accuracy record that is generated based on the order record and one or more images.

Manufacturing and/or distribution facilities may also require employees to position the plurality of items of an order at a predetermined orientation. For example, it may be desirable to position each of the plurality of items of each layer so that a bar code associated with each item is facing upward. A computer implemented verification process may include a device scanning each of the bar codes and may require that each bar code is positioned uniformly. Therefore, at Box 162, it may be desirable to randomly or routinely access the order record and associated images for each employee, based on a unique employee identifier, to determine whether or not the employee is positioning items according to the predetermined orientation. If, for example, the order record associated with images 40, 70, and 100 are accessed, it can be seen from the image 70 (FIG. 3) representing the second layer of the order that item 74 is not positioned with the bar code facing upward. From Boxes 158, 160, and 162, the method proceeds to an END, at Box 148. It should be appreciated that numerous reasons exist for accessing the order record and/or one or more images stored for a specific order.

It should be understood that the above description is intended for illustrative purposes only, and is not intended to limit the scope of the present disclosure in any way. Thus, those skilled in the art will appreciate that other aspects of the disclosure can be obtained from a study of the drawings, the disclosure and the appended claims.

What is claimed is:

1. An order processing system, comprising:
a staging area for receiving a shipping medium prior to shipment, wherein the shipping medium supports at least one item;
an imaging device positioned for capturing an image of the at least one item supported by the shipping medium; and
a data storage device configured to store the image and order information associated with the image.

2. The order processing system of claim 1, further including a triggering device operably connected to the imaging device for causing the imaging device to capture the image, wherein the triggering device is remote from the imaging device.

3. The order processing system of claim 1, further including a timer for causing the imaging device to capture the image a predetermined time period after a triggering event.

4. The order processing system of claim 1, wherein the data storage device is further configured to store a plurality of records, wherein each record includes at least one image and order information associated with the at least one image.

5. The order processing system of claim 4, wherein the order information includes at least one of an order identifier, at least one item identifier, a receiving party identifier, an employee identifier, and a date shipped.

6. The order processing system of claim 1, wherein the shipping medium is a box.

7. The order processing system of claim 1, wherein the shipping medium is a pallet and the pallet supports at least a first layer of items and a second layer of items.

8. The order processing system of claim 7, wherein the imaging device is further positioned above the staging area to capture a first image of the first layer and a second image of the second layer.

9. The order processing system of claim 1, further including a workstation for accessing the image during a predetermined claims period to determine if the at least one item supported by the shipping medium corresponds to a customer order.

10. A method of processing an order, comprising:
receiving an order, wherein the order identifies a plurality of items;
storing an order record associated with the order in a data storage device;
supporting a first layer of the plurality of items with a shipping medium;
capturing a first image of the first layer of the plurality of items supported by the shipping medium with an imaging device;
associating the first image with the order record; and
shipping the shipping medium.

11. The method of claim 10, further including:
supporting a second layer of the plurality of items with the shipping medium;
capturing a second image of the second layer of the plurality of items supported by the shipping medium with the imaging device; and
associating the second image with the order record.

12. The method of claim 11, further including:
securing the first and second layers of the plurality of items to the shipping medium;
capturing a final image of the shipping medium once secured; and
associating the final image with the order record.

13. The method of claim 12, further including:
deleting the order record and the first, second, and final images after a predetermined claims period has expired.

14. The method of claim 11, further including:
receiving an inquiry regarding the order during a predetermined claims period; and
accessing the order record and the first and second images associated with the order in response to the inquiry.

15. The method of claim 14, further including:
reviewing the first and second images to determine if the plurality of items supported by the shipping medium correspond to the order.

16. The method of claim 10, wherein the supporting step further includes:
positioning the plurality of items of the first layer at a predetermined orientation.

17. The method of claim 16, wherein the supporting step further includes:
positioning each of the plurality of items of the first layer so that a bar code associated with each of the plurality of items is facing upward.

18. The method of claim 16, further including:
accessing an order record associated with a unique employee identifier from the data storage device; and
generating an order accuracy report based on the order record.

19. The method of claim 18, further including:
reviewing the first image to determine if the plurality of items supported by the shipping medium are positioned according to the predetermined orientation.

20. A method of processing an order, storing information associated with the order, and accessing the information, comprising:
receiving an order, wherein the order identifies a plurality of items;
storing an order record associated with the order in a data storage device;
supporting a first layer of the plurality of items with a shipping medium;
capturing a first image of the first layer of the plurality of items supported by the shipping medium with an imaging device;
supporting a second layer of the plurality of items with the shipping medium;
capturing a second image of the second layer of the plurality of items supported by the shipping medium with the imaging device;
securing the first and second layers of the plurality of items to the shipping medium;
capturing a final image of the shipping medium once secured;
associating the first, second, and final images with the order record;
shipping the shipping medium; and accessing the order record and the first, second, and final images.
